(19) United States
(12) Patent Application Publication
(10) Pub. No.: US 2005/0142527 A1
(43) Pub. Date: Jun. 30, 2005

(54) Method of making review program from interactive learning software/firmware

(75) Inventor: Hao-Ming Yeh, Taipei City (TW)

Correspondence Address: BACON & THOMAS, PLLC, 625 SLATERS LANE, FOURTH FLOOR, ALEXANDRIA, VA, 22314, US

(73) Assignee: CRAFTSMAN SOFTWARE CO., LTD., TAIPEI CITY (TW)

(21) Appl. No.: 10/817,789

(22) Filed: Apr. 6, 2004

(30) Foreign Application Priority Data
Dec. 31, 2003 (TW) 92137839

(51) Int. Cl. G09B 7/00

(52) U.S. Cl. 434/307 R

(57) ABSTRACT

A method of making the review program from an interactive learning software/firmware includes steps of (a) sequentially recording the file name of each curricular video/audio file, which is used by the user while the user manipulates a learning unit, on a label file, (b) converting each curricular video/audio file into a playback sequence file by sequentially renaming the file name of each curricular video/audio file, the file name of the playback sequence file containing information (digit/alphabet/character) for identification of sequential arrangement, and (c) sequentially combining the playback sequence files to generate the review program. Accordingly, the user can review entire previous learned content by means of the review program.

### BACKGROUND OF THE INVENTION

1. Field of the Invention

The present invention relates generally to computer software for learning, and more particularly to a method of making a review program from an interactive learning software/firmware.

2. Description of the Related Art

Conventional learning software, such as language learning software, is generally installed in a computer system or is made as a CD (compact disc) or a DVD (digital video disc) to be played by a player, and then the user can manipulate the learning software via a keyboard, a mouse, or a remote controller in connection with the computer system, watch the visual images via a monitor, a television, or other display device, and hear the audio sound or music via the computer system or a speaker system, such as television, speakers, or earphones, thereby attaining the goal for learning.

The user can interact with the commercially available learning software merely during the learning process; however, when the user quits the learning and then closes the software, the user fails to review the content which was learned previously and has to restart manipulating the software and learning again. Each user has different learning processes, such that the user usually fails to repeat the previous manipulation of the software and to review the same content learned previously while repeating the learning, thereby incurring ineffective review and learning.

In addition, the aforementioned learning software is limited to the computer hardware. When the user stays outdoors and fails to carry the computer system therewith, the user fails to review the previous learned content. Even if the computer system is a notebook computer which can be carried with the user, it is still very inconvenient to carry the notebook computer which causes a burden for the user.

### SUMMARY OF THE INVENTION

The primary objective of the present invention is to provide a method of making a review program from an interactive learning software/firmware; the method generates a review program arranged sequentially by curricular video/audio files containing the user's previous learned content for the user's further complete review.

The secondary objective of the present invention is to provide a method of making a review program from an interactive learning software/firmware, the method generates a preferably vivid review program arranged sequentially by a plurality of transitional video/audio files inserted among the curricular video/audio files.

The third objective of the present invention is to provide a method of making a review program from an interactive learning software/firmware; the review program made by the method can be inputted into a portable device or medium for playback.

The foregoing objectives of the present invention are attained by the method of making the review program from the interactive learning software/firmware. The interactive learning software/firmware is installed in an interactive device and is prepared with at least one learning unit to be operated by the user for learning before operation, the learning unit having at least one curricular video/audio file. The method includes steps of (a) sequentially recording the file name of each curricular video/audio file, which is used by the user while the user manipulates the learning unit, on a label file, (b) converting each curricular video/audio file into a playback sequence file by sequentially renaming the file name of each curricular video/audio file, the file name of the playback sequence file containing information (digit/alphabet/character) for identification of sequential arrangement, and (c) sequentially combining the playback sequence files to generate the review program. Accordingly, the user can review entire previous learned content by means of the review program.

### BRIEF DESCRIPTION OF THE DRAWINGS

FIG. 1 is a schematic view of a first preferred embodiment of the present invention, showing a learning software/firmware installed in an interactive device;

FIG. 2 is a schematic view of the first preferred embodiment of the present invention, showing that file names of curricular video/audio files are sequentially recorded on a label file;

FIG. 3 is a schematic view of the first preferred embodiment of the present invention, showing that the curricular video/audio files are converted into playback sequence files by sequentially renaming the file names of the curricular video/audio files to generate a review program;

FIG. 4 is a schematic view of the first preferred embodiment of the present invention, showing that the review program is outputted from the interactive device and inputted into a playback device;

FIG. 5 is a schematic view of a second preferred embodiment of the present invention, showing that the learning software/firmware and transitional video/audio files installed in the interactive device;

FIG. 6 is a schematic view of the second preferred embodiment of the present invention, showing that the sequence of the video/audio files;

FIG. 7 is a schematic view of the second preferred embodiment of the present invention, showing that the curricular video/audio files are converted into the playback sequence files by sequentially renaming the file names of the curricular video/audio files to generate a review program;

FIG. 8 is a schematic view of the second preferred embodiment of the present invention, showing that the review program is outputted from the interactive device and inputted into a playback device;

FIG. 9 is a schematic view of the second preferred embodiment of the present invention, showing that the review program is outputted from the interactive device and inputted into a personal digital assistant (PDA);

FIG. 10 is a schematic view of the second preferred embodiment of the present invention, showing that the review program is outputted from the interactive device and inputted into a multimedia mobile phone; and

FIG. 11 is a schematic view of a third preferred embodiment of the present invention, showing that the review program is outputted from the interactive device and inputted into a storage media.

### DETAILED DESCRIPTION OF THE INVENTION

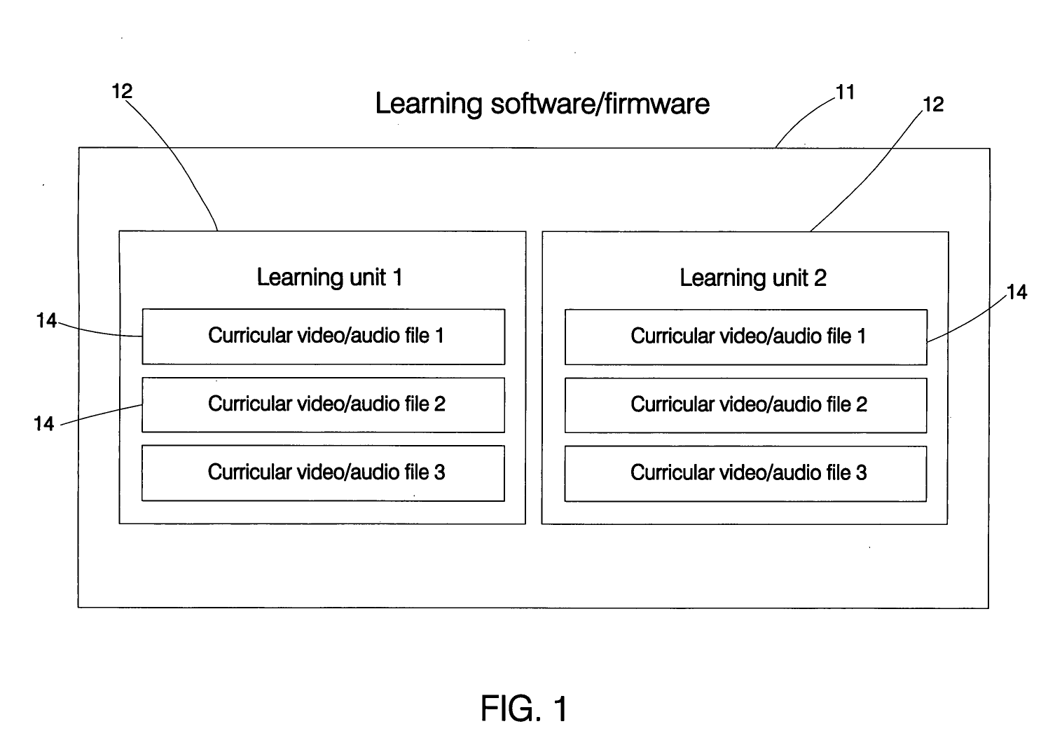

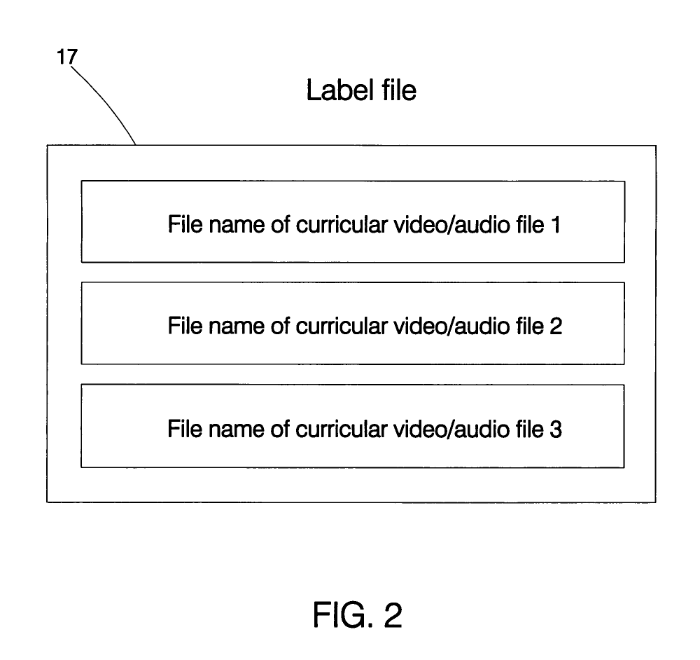

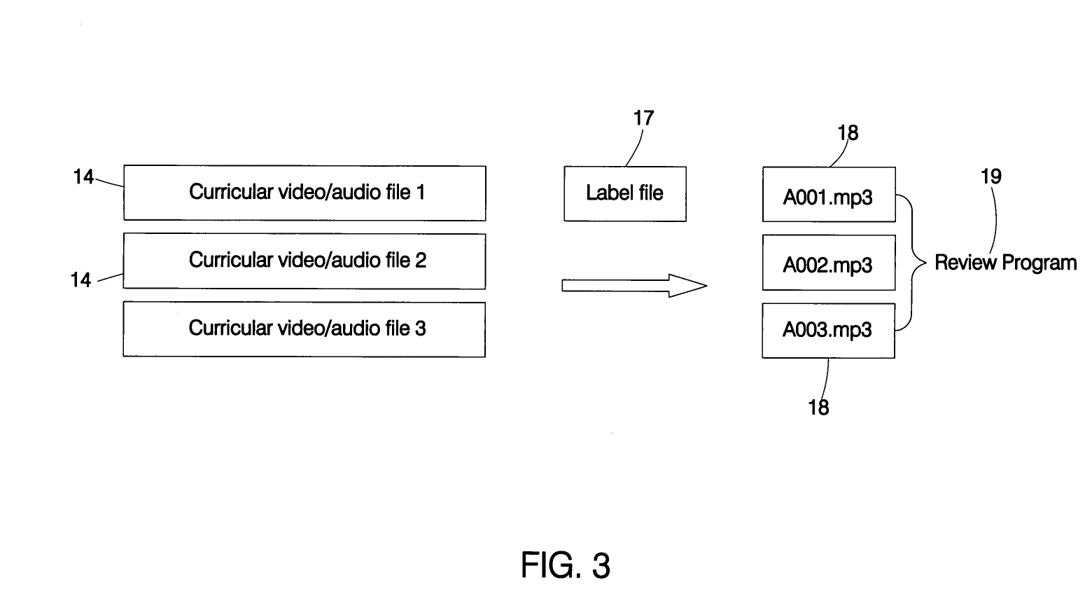

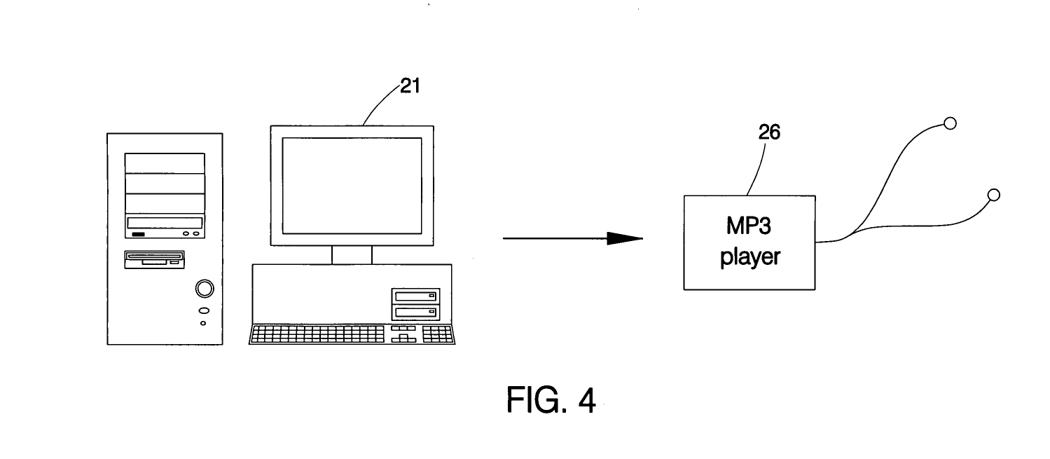

Referring to FIGS. 1-4, a method of making a review program from an interactive learning software/firmware is constructed according to a first preferred embodiment of the present invention. The interactive learning software/firmware 11 is installed in an interactive device 21, which can be a computer system, such as personal computer (PC), notebook PC, personal digital assistant (PDA), mobile phone, electronic book reader, or set-top box for wideband digital television (TV). Before the learning software/firmware is operated by the user, at least one learning unit 12 has to be prepared in advance by installing the learning unit 12 in the interactive device 21 or by downloading the learning unit 12 from a remote server on Internet into the interactive device 21. The learning unit 12 includes at least one curricular video/audio file 14. The interactive device 21 can be connected with remote networks to enable the learning unit 12 to be extendibly saved into a remote networking database. The method includes steps as follows.

(a) Record file name of each curricular video/audio file 14, which is used by the user while the user manipulates the learning unit 12, sequentially on a label file 17 to record the user's operating process of learning. Each of the three curricular video/audio files 14 is in MPEG Layer 3 (MP3) format. The label file 17 can be saved into the interactive device 21 or a remote networking server connected with the interactive device 21 or an external storage device.

(b) Convert each curricular video/audio file 14 into a playback sequence file 18 by sequentially renaming the file name of each curricular video/audio file 14. The file name of each playback sequence file 18 contains information of digit/alphabet/character for identification of sequential arrangement.

(c) Sequentially combine the playback sequence files 18 to generate a review program 19.

Hereto, the review program 19 contains entire previous learned content and the user can sequentially play the review program for review.

Furthermore, the method of the first preferred embodiment of the present invention can further contain the following step:
(d) Output the review program 19 from the interactive device 21 and then input the same into a playback device 26, which is embodied as an MP3 player. While playing the review program via the playback device 26, the playback sequence files 18 are played according to the sequential arrangement thereof. The user can carry the playback device 26 along therewith and listen to the same at any time.

From the above steps, what the user watches or hears from the learning unit 12 can be completely recorded on the label file 17, the playback sequence files 18 can be sequentially combined to generate the review program 19, and the review program 19 can be inputted into the playback device 26, such that the user can carry the playback device 26 along therewith and listen to the review program 19 at any time.

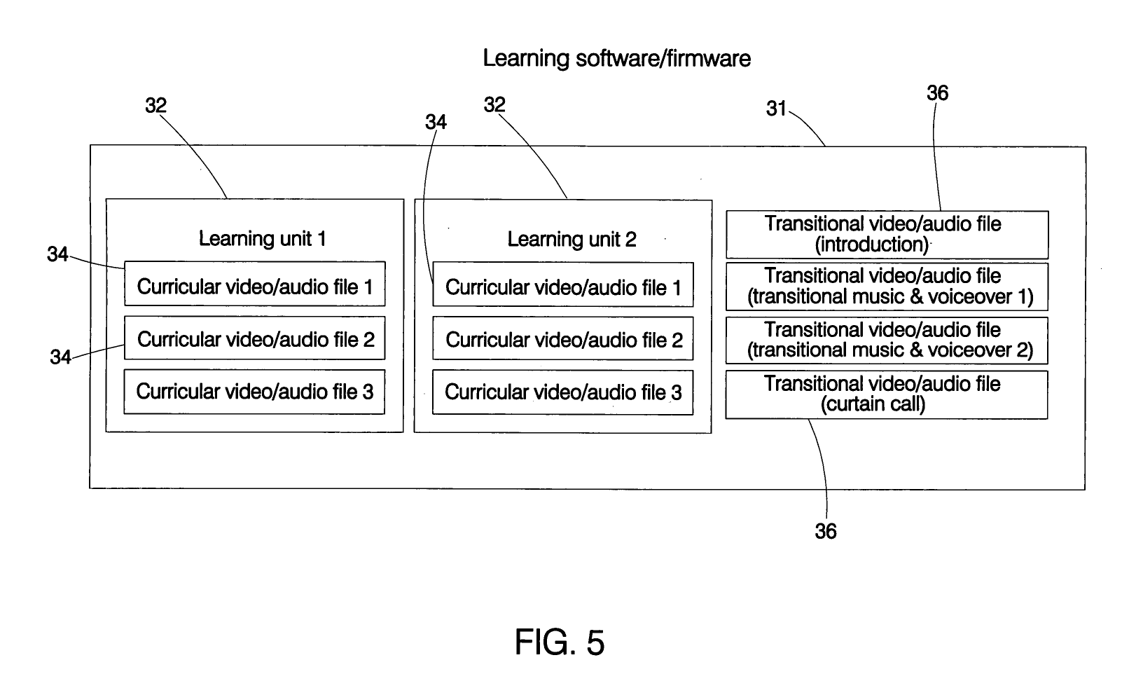

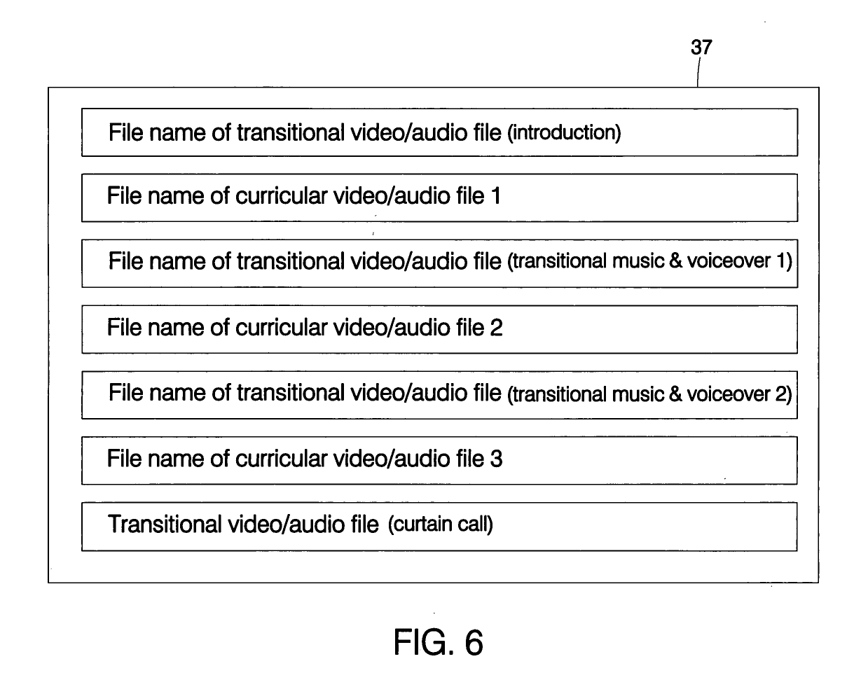

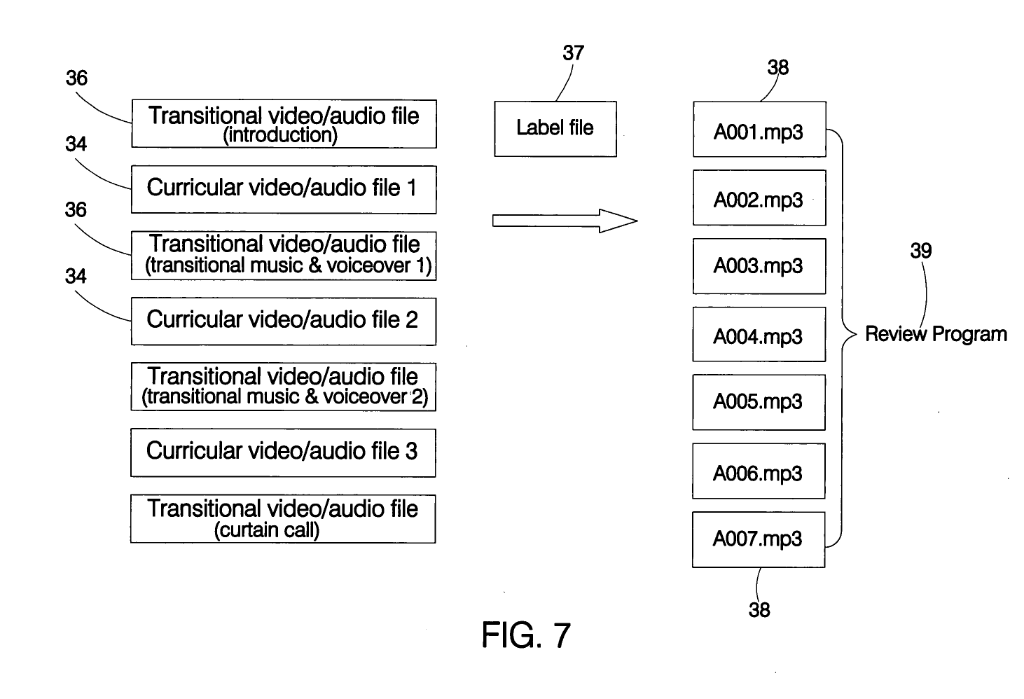

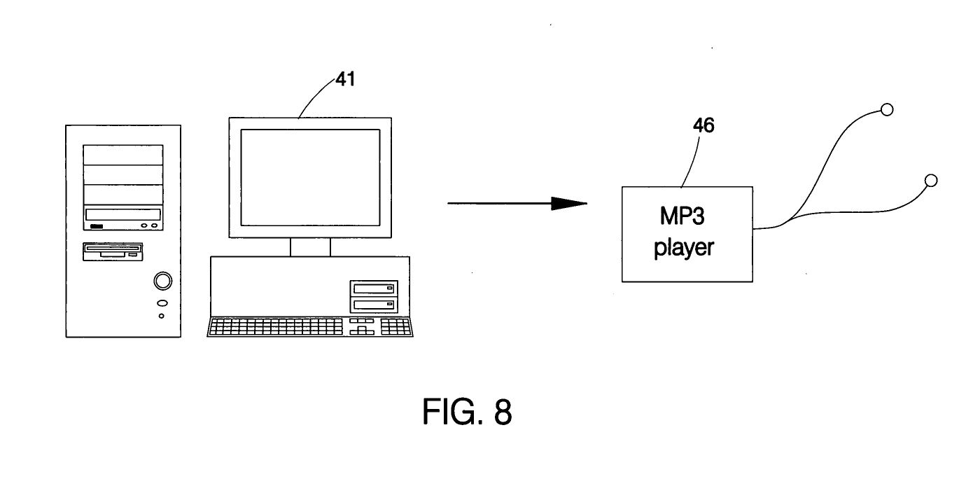

Referring to FIGS. 5-8, the method of making the review program from the interactive learning software/firmware is constructed according to a second preferred embodiment of the present invention. The learning software/firmware 31 and the interactive device 41 are substantially identical to those of the first preferred embodiment. The method includes steps as follows.

(A) Prepare a plurality of transitional video/audio files 36, which are in MP3 format and saved into the interactive device 41. Each of the transitional video/audio files 36 can be introduction, transitional music, voiceover, curtain call, etc. for connecting unrelated files.

(a) Record the file name of each curricular video/audio file 34, which is used by the user while the user manipulates the learning unit 32, sequentially on the label file 37; select proper transitional video/audio files 36, each of which property corresponds to the curricular video/audio file 34, from the transitional video/audio files 36; insert the proper transitional video/audio files 36 among the corresponding curricular video/audio files 34; record file names of the proper transitional video/audio files 36 on the label file 37 and insert the same among the file names of the corresponding curricular video/audio files 34 to generate a new sequence of the file names in the label file 37 to record the user's operating process of learning. The label file 37 can be saved into the interactive device 41 or a remote networking server connected with the interactive device 41 or an external storage device.

(b) Convert each of the curricular video/audio files 34 and the transitional video/audio files 36 into the playback sequence file 38 by sequentially renaming the file names of the curricular video/audio files 34 and the transitional video/audio files 36. The file name of each playback sequence file 38 contains information of digit/alphabet/character for identification of sequential arrangement.

(c) Sequentially combine the playback sequence files 38 to generate the review program 39. Hereto, the review program 39 contains entire previous learned content and the user can sequentially play the review program for review.

(d) Output the review program 39 from the interactive device 41 and then input the same into a playback device 46, which is embodied as an MP3 player. While playing the review program 39 via the playback device 46, the playback sequence files 38 are played according to the sequential arrangement thereof. The user can carry the playback device 46 along therewith and listen to the same at any time. The review program 39 contains the entire previous learned content and thereby the user can sequentially play the review program for review.

From the above steps, what the user watches or hears from the learning unit 32 can be completely recorded on the label file 37, the transitional video/audio files 36 as prepared in the step (a) can be inserted among the label files 37, the label files 37 can be sequentially combined to generate the review program 39, and the review program 39 can be inputted into the playback device 46, such that the user can carry the playback device 46 along therewith and listen to the review program 39 at any time.

It is to be noted that the format of the video/audio files in the present invention is not limited to MP3 and can alternatively be AVI (Audio Video Interleaved animation) or MPEG (Motion Picture Experts Group) or other equivalents.

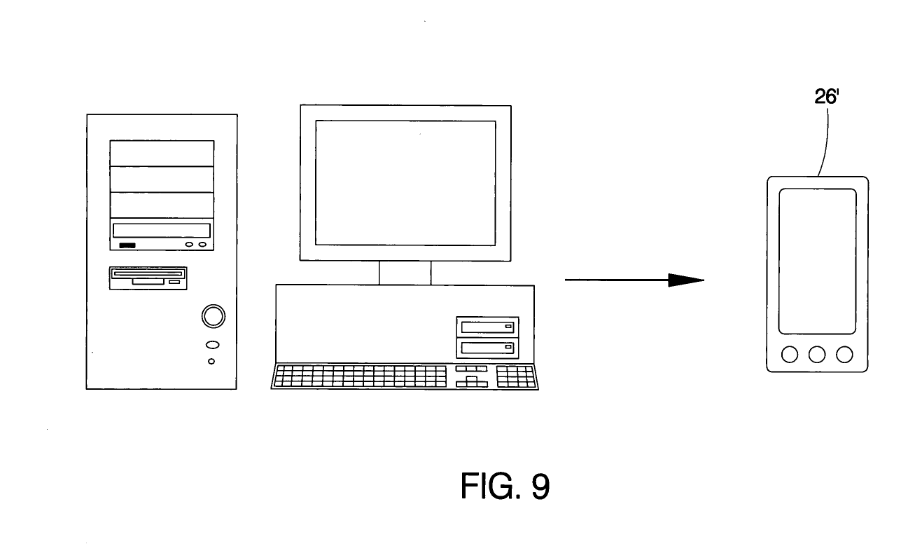

Referring to FIG. 9, the playback device 26′ as mentioned in the step (d) of the second preferred embodiment of the present invention can alternatively be a PDA to facilitate the user to portably review completely what the user learned from the learning unit via the interactive device.

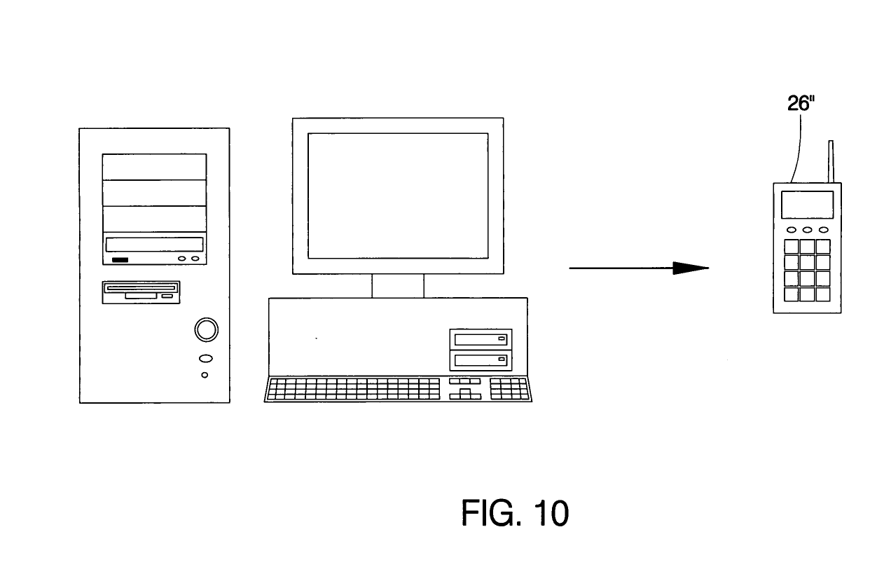

Referring to FIG. 10, the playback device 46 as mentioned in the step (d) of the second preferred embodiment of the present invention can alternatively be a multimedia mobile phone 26″ for playing completely what the user learned from the learning unit via the interactive device.

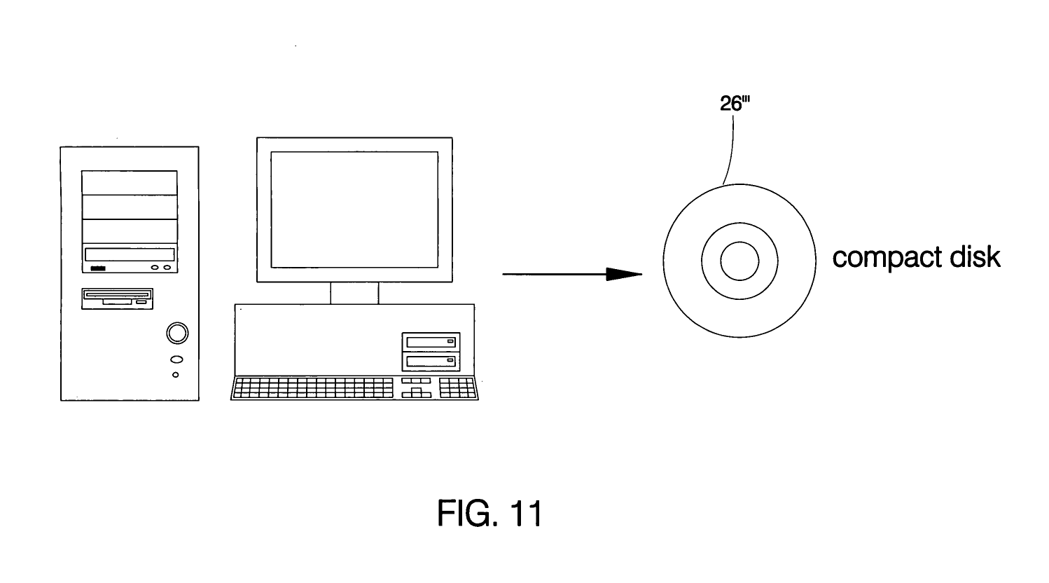

Referring to FIG. 11, the method of making the review program from the interactive learning software/firmware is constructed according to a third preferred embodiment of the present invention and is different from the aforementioned preferred embodiment only by the following recitation. In the step (d′), the playback files are outputted from the interactive device and inputted into a storage media 26′″, which is embodied as a CD. The storage media 26′″ can be directly put into a CD player or a CD walkman for playback to also facilitate the user to portably review completely what the user learned from the learning unit via the interactive device.

It is to be noted that the present invention is not a rule or a method implemented only by human intelligence but a method of generating a review program which can be implemented by a learning software/firmware. The review program is portable to facilitate the user to watch or listen to it via a proper playback device while the user is awaiting bus or people or in other situation, such that the user can have preferably complete and effective review to further have preferably effective learning.

1. A method of making a review program from an interactive learning software/firmware, said learning software/firmware being installed in an interactive device, a learning unit being prepared before said learning software/firmware is manipulated by the user, said learning unit including a curricular video/audio file, said method comprising steps of:
(a) recording file name of each curricular video/audio file, which is used by the user while the user manipulates the learning unit, sequentially on a label file;
(b) converting each curricular video/audio file into a playback sequence file by sequentially renaming the file name of each the curricular video/audio file, the file name of each playback sequence file containing information of digit/alphabet/character for identification of sequential arrangement; and
(c) sequentially combining each playback sequence file to generate a review program;
whereby the review program provides complete previous learned content for the user's view.

2. The method as defined in claim 1 further comprises a step (A) of preparing a plurality of transitional video/audio files and saving the same into said interactive device before the step (a), wherein said step (a) further comprises selecting proper transitional video/audio files, each of which property corresponds to said curricular video/audio file, from said transitional video/audio files, inserting said proper transitional video/audio files among said curricular video/audio files, and recording the file names of said proper transitional video/audio files into said label file and inserting the same among the file names of the corresponding curricular video/audio files.

3. The method as defined in claim 1, wherein each of said video/audio files is in MP3 (MPEG Layer 3) format.

4. The method as defined in claim 1 further comprising a step (d) of outputting said playback files from said interactive device and inputting the same into a playback device, said playback files being played subject to the sequential arrangement thereof by said playback device.

5. The method as defined in claim 4, wherein said playback device is an MP3 player.

6. The method as defined in claim 4, wherein playback device is a PDA (personal digital assistant).

7. The method as defined in claim 4, wherein said playback is a multimedia mobile phone.

8. The method as defined in claim 1 further comprising a step (d) of outputting said playback files from said interactive device and inputting the same into a storage media.

9. The method as defined in claim 8, wherein said storage device is a CD (compact disc).
